(19) United States
(12) Patent Application Publication
(10) Pub. No.: US 2026/0322597 A1
(43) Pub. Date: Oct. 15, 2026

(54) SYSTEMS AND METHODS FOR QUANTUM KEY DISTRIBUTION NETWORKS

(71) Applicant: Kennesaw State University Research And Service Foundation, Inc., Kennesaw, GA (US)

(72) Inventor: Tu Ngoc Nguyen, Kennesaw, GA (US)

(21) Appl. No.: 19/026,167

(22) Filed: Jan. 16, 2025

Related U.S. Application Data
(60) Provisional application No. 63/621,525, filed on Jan. 16, 2024.

(51) Int. Cl. H04L 9/08

(52) U.S. Cl. CPC H04L 9/0855

(57) ABSTRACT

A system for implementing a quantum key distribution network, the system comprising: one or more quantum transmitters configured to transmit quantum encoded photons; a single state receiver, configured to receive the photons and determine encoded bits under a first protocol; a bell state receiver configured to receive quantum encoded photons under a second protocol; and a manager configured to determine a basis of encoding of the quantum encoded photons and to control communication between the one or more quantum transmitters and the single state receiver based on the first protocol or the bell state receiver based on the second protocol.

### CROSS-REFERENCE TO RELATED APPLICATIONS

This application is a Nonprovisional of and claims the benefit to provisional Application No. 63/621,525, filed Jan. 16, 2024, each of which are hereby incorporated by reference in its entirety for any and all purposes.

### BACKGROUND

In building the next generation networking, cryptography is one of the most crucial aspects to be considered. Due to the interconnecting nature of the internet, information packets are usually relayed through multiple intermediate hops on the network, and rarely with any obscurity. For our current network standard, Public Key Infrastructure (PKI) and encryption algorithms are put in place to ensure obfuscation of the packets as being relayed. However, the rapid development of the quantum computers is a looming threat to the current globally deployed system. A promising technology to resolve this problem is Quantum Key Distribution (QKD), where the obfuscation of the exchanged information is guaranteed by the law of quantum physics instead of the computational complexity of a math problem. This makes QKD an important prospect for the future development of networking and cryptography.

In QKD, a photon, which exerts quantum properties and cannot be cloned, carries obfuscated information. The photon can be transmitted from between two points of communication. The development of QKD, hence, depends heavily on the advancement of optical technology. Traditional QKD systems employ low-noise optical fibers as the transmission media, which requires dedicated dark fiber resources to implement and significantly incur the cost of upgrade. However, recent network set ups demonstrated the feasibility of applying wavelength division multiplexing (WDP) to parallel quantum-classical communication over the same fiber.

Even though optical fiber and free space QKD has made significant progress on the experimental front, only QKD products designed for optical fiber are available for the consumer. These devices are built on point-to-point QKD protocols such as Bennett-Brassard 1984 (BB84), which can only establish secrets exclusively between two points of direct fiber connection. In the context of a network, to address problem of multiple-hops QKD, the trusted relay technique is implemented widely for practical QKD networks. The precondition of this method is for all the intermediate nodes to be trustable, as the end-to-end secrets are necessarily stored and relayed through each of them. This is a huge shortcoming that prevents QKD from extending beyond any local networking utility and towards the vision of quantum internet.

To eliminate the trusted precondition, several other untrusted relay techniques, such as entanglement swapping and optical switching, has also been proposed. Entanglement swapping in quantum repeaters is an exciting field and has amassed devotion in recent years; the technology is not mature enough to be deployed in-field. And while optical switching has been employed in many QKD networks, they are not scalable due to the loss factor of fiber optics.

Improvements are needed.

### SUMMARY

Considering entanglement-based QKD, while with entanglement swapping, in which pairs of one-hop entanglement can be “glued” together, promises multi-hop and long-distance end-to-end entanglement, and seemingly a perfect candidate for implementing untrusted relay, in reality, this methodology is extremely complex due to the fragile nature of entanglement. Furthermore, there are few experimental demonstrations for multi-hop entanglement-based QKD in the current literature, and tremendous development effort is still required to bring about this technology. On the other hand, the MDI-QKD protocol has been rigorously demonstrated in the field over the last few years.

Despite its limitation of only being able to facilitate untrusted two-hops secret exchange, the resiliency of MDI-QKD makes it the perfect candidate to practically implement inter-collaboration between the private QKD networks in the near-term future. Described herein is a multi-protocol QKD node architecture that enables untrusted relay. Described herein is a Hybrid Protocols QKD (HyPr-Q) network model that has the potential of lowering the costs of intra-connection of private QKD network. Described herein is an algorithm to find and schedule a relay path with QKD resources in the HyPr-Q network model. Described herein, as part of a NetSquid simulation of the algorithm, is a quantum circuit that replicate Bell-state measurement results pattern of the MDI-QKD protocol.

Traditional QKD network requires the consumption of dark fiber to set up the quantum transmission. Thanks to the advancements in wavelength division multiplexing (WDP), QKD systems can be deployed over any conventional network with optical fiber connections. The framework of integration is laid out as follows. The optical wavelengths are segregated into three different categories, connecting the network nodes in their three different layers of operation: 1) the substrate layer, connected by the quantum channels (QCh), operate to send and receive the quantum-encoded photons; 2) the protocol layer, connected by the public channels (PCh), operate to filter the quantum information during a QKD protocol execution; and 3) the applications layer, connected by the data channels (DCh), is where applications run and communicate securely with a secret-key supplemented by the QKD protocols.

With the recent practicality demonstration of managing QKD resources with software-defined networking (SDN), following this, many SDN-for-QKD architectures have been proposed. The operational flow of an architecture may be as follows. First, with the objective of periodically supplying secret-keys to secure applications, a key buffering cycle starts with the applications expressing key requests to an SDN controller. Second, the controller then finds and allocates the QKD resources to fulfill the secret-key requests. Third, a scheduling result is compiled into a control sequence, which is delivered to a quantum protocol manager (QPM). Fourth, the QPM receives instructions to carry out the QKD protocols execution and carries the QKD protocols execution out. Fifth, the resulting secret-keys are then supplied to the applications layer. Sixth, the resulting secret-keys are consumed to encrypt new secure connections.

In the context of a network, there are different methods to establishing a secret-key between two nodes that are either directly connected or multiple hops away from each other. Namely, point-to-point (P2P) QKD is facilitated by the BB84 protocol, which can be used to securely establish secret-key in a one-hop set up. When the nodes are more than two hops away, there are several options: 1) trusted relay via one-time pad, 2) untrusted relay via the MDI-QKD, or 3) hybrid relay by combining one-time pad with the mixing and matching between BB84 and MDI-QKD protocols on the relay path.

An example one-time pad method may comprise trusted relays v₁, v₂, and v₃, a BB84 connection between v₁ and v₂(K1), and a BB84 connection between v₂ and v₃ (K2). With K1 and K2 established between v₁↔v₂ and v₂↔v₃ (via BB84), the goal is for v₁ and v₃ to share the same secret-key. To this end, a bit-wise exclusive OR (XOR) operation is performed at v₂ to obtain the one-time pad K1⊕K2. The result is sent to v₃, where the reverse XOR operation K2⊕(K1⊕K2) is performed to obtain the mutual secret-key K1. Throughout the process, the intermediate node v₂ is aware of the mutual secret-key, and hence must be trusted.

An example MDI-QKD model may comprise trusted relays v₁ and v₃ and untrusted relay v₂, which may link v₁ and v₃. In the example, v₁ and v₃ can establish an MDI-QKD connection (K3) without “leaking” the secret-key to v₂, hence it is an untrusted relay scheme.

An example hybrid relay model may comprise trusted relays v₁, v₂, v₃, and v₅ and untrusted relay v₄. The hybrid relay model may comprise a 4-hops QKD. The hops may be sequenced such that v₁ is adjacent to v₂, v₂ is adjacent to v₃, v₃ is adjacent to v₄, and v₄ is adjacent to v₅. The hybrid relay model may comprise BB84 connections between v₁↔v₂, v₂↔v₃, and MDI-QKD is executed between v_{3↔15}. One-time pad is employed at trusted nodes v₂ and v₃, while v₄ is used as an untrusted node on the path.

Disclosed herein is a novel inter-collaborating QKD network architecture, comprising a mathematical model to operate this new scheme and algorithms to facilitate the secret-key requests in the buffering cycle. Disclosed herein is the hybrid protocols QKD network (HyPr-Q) model as well as analyze its properties, prospects and the significance of its contribution to quantum internet.

### BRIEF DESCRIPTION OF THE DRAWINGS

The following drawings show generally, by way of example, but not by way of limitation, various examples discussed in the present disclosure. In the drawings:

FIG. 1 shows examples private networks according to the systems and methods disclosed herein.

FIG. 2 shows examples Quantum Key Distribution (QKD) devices according to the systems and methods disclosed herein.

FIG. 3 shows example trustable-aware relays according to the systems and methods disclosed herein.

FIG. 4 shows example time-slot allocation according to the systems and methods disclosed herein.

FIG. 5 shows example device-to-device paths according to the systems and methods disclosed herein.

FIG. 6 illustrates two approaches in multi-hop QKD for establishing a secure secret-key from v₁ to v₃ via the intermediate node v₂.

FIG. 7 illustrates the seamless Resolution of the compromised CA issue through the integration of QKD with PQC.

FIG. 8 shows an example of e2e QKD paths.

FIG. 9 shows a design for quantum network simulator modules.

### DETAILED DESCRIPTION

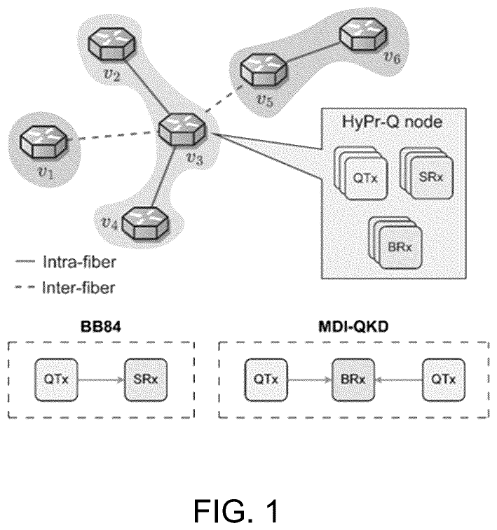

FIG. 1 demonstrates the inter-connection of two different private networks identified by node shapes: square and circle. Notice that due to the geographical distance, a direct fiber connection between v₁ and v₅ is not possible. Hence, in order to establish secret-key between these square nodes, there are two approaches: 1) build and secure an intermediate physical location for a new QKD square node, 2) collaborate with the circle node v₃ via untrusted relay. Despite the more significant cost of deployment, the first approach is adopted by traditional QKD network designs that are purely trusted. The second approach is naturally more favorable. However, it requires v₁, v₃ and v₅ to be able to facilitate an untrusted QKD protocol. In other words, these QKD nodes need to be upgraded.

The QKD node architecture enables the QKD nodes to facilitate both BB84 and MDI-QKD protocols. FIG. 1 illustrates the component structure of an example multi-protocol node. The example node comprises four main components: three optical QKD devices-a quantum transmitter (QTx), a single-state receiver (SRx), and a Bell-state receiver (BRx), and one software component-a quantum protocols manager (QPM). FIG. 1 illustrates an intra-network relay. FIG. 1 illustrates an inter-network relay. The intra-network relay of FIG. 1 and the inter-network relay of FIG. 1 intersect at v₃ on FIG. 1.

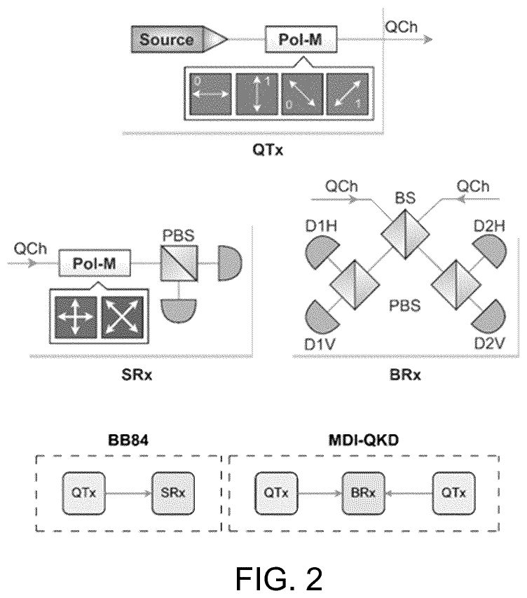

FIG. 2 illustrates an optical structure of QKD devices. FIG. 2 illustrates a communication model for QKD devices. A QKD device may use quantum-encoded photons. For prepare-and-measure QKD protocols, the classical bit is encoded into the photon by setting its polarization direction. There are four different polarization directions: horizontal |H [symbol] , vertical |V), diagonal|+ [symbol] and anti-diagonal |→ [symbol] that encode the classical bits O_{|H)}, 1_{|V)}, 1_{|+)} and 0_{|-)}, respectively. As shown in the QTx of FIG. 2, photons emitted from the source travel through the polarization modulator (Pol-M), the resulting qubits head to the quantum receiver through the QCh.

A QKD device may comprise a single-state receiver, such as the SRx shown in FIG. 2. As per the BB84 communication model shown in FIG. 2, to complete the BB84 protocol, the SRx is set up at the photon receiving end to obtain and measure the encoded bits. FIG. 2 shows that a polarization modulator (Pol-M) is set up at the photon input to randomize between two measurement bases: rectilinear (Z) and diagonal (X). The measurement set up is fairly simple with a polarizing beam splitter (PBS) and two photon detectors. The polarization state of a photon is determined correctly only with matching encoding and measurement basis, i.e., |H [symbol] , |V [symbol] for Z and |+ [symbol] , |− [symbol] for X.

A QKD device may comprise a Bell-state receiver, such as the BRx shown in FIG. 2. As per the MDI-QKD communication model shown in FIG. 2, model, the MDI-QKD protocol is set up between three parties. The encoded qubits are sent from the two end nodes to the intermediate node, where the encoded qubits are received in pairs by the BRx. As FIG. 2 shows, the BRx is an apparatus of beam splitter (BS), polarizing beam splitter (PBS) and photon detectors (D1H, D2H, D1V, D2V). For each pair of incoming photons, the intermediate node will attempt to project the photons into a Bell-state, a successful measurement event will result in either ψ+ or ψ−. The secret bit can only be established when two conditions are satisfied: 1) the encoding basis matches between two end nodes, and 2) the Bell-state projection at the intermediate node is successful.

A QKD device may comprise key distribution software. The QPM may be designed to unify the software control over the operations of QKD protocols execution and one-time pad distribution. To operate the QKD protocols execution, the QPMs may keep track of the encoding and measurement status of the QKD devices and utilize the PChs to communicate with each other. Such process is employed for 1) confirming the bases of encoding and measurement in BB84, 2) confirming the encoding bases of two end nodes in MDI-QKD, and 3) announcing the Bell-state projection results from the intermediate node to the end-nodes. With the exchanged protocol information, the QPM discards failed measurement cases and establishes the mutual QKD secret bits. To operate the one-time pad distribution, the QPM performs the XOR calculations and delivers the results via the PChs.

Although a polarization method was described above to encode a photon with quantum information, other methods, such as phase-encoding, can also be integrated in similar fashion.

The QTx can be used as a quantum-encoded photon transmitter for both BB84 and MDI-QKD communication protocols. Both protocols can run with the same encoding scheme. Various descriptions of MDI-QKD in the literature directly calls for photons of BB84 states.

The MDI-QKD protocol is facilitated by the Bell-state receiver (BRx) as an untrusted relay party. Even with the measurement results obtained by the BRx and the transmission bases being exchanged, the intermediate party will still not be able gain any useful information about the secret-key being established in an MDI-QKD protocol.

The secret-key rate of a QKD protocol is constant for the same facilitating optical fiber(s). This is a reasonable assumption since the signal loss and delay in the optical fiber is the largest contributing factor to the speed of a QKD protocol.

The systems and methods described herein may comprise quantum repeater substitutes. Due to the extremely fragile nature of entanglement, QKD with entanglement-swapping is still far removed from any practical usage. MDI-QKD, on the other hand, is a highly robust protocol and has been rigorously demonstrated on the field in recent years.

The systems and methods described herein may use minimal upgrades. Observing the quantum communication model, a conventional P2P QKD node is already equipped with QTx, and SRx devices. By designing the QTx to be used in both protocols, once available, the BRx device can be integrated into a P2P QKD node, hence, grant the existing nodes with the integrated BRx device the ability to facilitate MDI-QKD as the untrusted relay and serve as such in collaboration with external networks. And by adopting the HyPr-Q architecture, the upgrade cost is reduced. The hardware enhancement only concerns the MDI-QKD photon receiver (BRx) and for software enhancement, some additional protocol execution instructions (QPM).

In a HyPr-Q network, the controller must operate to find appropriate relay path and schedule sufficient QKD resources for the key requests. Below are explanations of the problem of Time-slot Allocation for Trustable-Aware Relay (TATAR) of the network model. The notations are listed in Table I.

TABLE I
LIST OF NOTATIONS

| Notation | Definition |
|---|---|
| [symbol] ( [symbol] , ε) | Topology of the hybrid protocols network |
| [symbol] | Set substrate QKD nodes |
| ε | Set of fiber connection among the nodes |
| [symbol] _{u,v} | Set of QKD links on edge (u, v) |
| γ_{u,v} | BB84 key rate on between two nodes u, v |
| γ_{u,v,w} | MDI-QKD key rate between v, ω through u |
| ${D}_{υ}^{Q}$ | Set of QTx devices at node v |
| ${D}_{υ}^{S}$ | Set of SRx devices at node v |
| ${D}_{υ}^{B}$ | Set of BRx devices at node v |
| (v, Q) | A QTx device at node v |
| (v, S) | A SRx device at node v |
| (v, B) | A BRx device at node v |
| (u - v) | A QKD link on edge (u, v) |
| [symbol] | Set of requests in a buffering cycle |
| r | A QKD key request in [symbol] |
| sᵣ | Source node of r |
| dᵣ | Destination node of r |
| μᵣ | Set of untrusted nodes of r |
| [symbol] | Number of key requested in r |
| τᵣ | Time window of r |
| T | Set of time slots that encompasses all τᵣ |
| t | A time slot in T |
| ${α}_{u , υ}^{( r , t )}$ | Binary variable, whether {(u, Q), (u − v), (v, S)} are allocated for r at t |
| ${β}_{u , υ}^{( r , t )}$ | Binary variable, whether {(u, Q), (u − v), (v, B)} are allocated for r at t |
| ρ^{(r)} | Binary variable, whether request r is fulfilled |

[symbol]

indicates data missing or illegible when filed

The topology of the network is modeled as G(V, E), where V represent the set of QKD nodes, and E represent the edges, which are the optical fiber connection between these nodes. The sets of devices in node v∈V is modeled as D^{Q}, D^{S}, D^{B} for QTx, SRx, and BRx, respectively. The number of wavelengths reserved for quantum communication on edge (u, v)∈E, i.e. quantum channels, is modeled as C_{u,v}. Each quantum channels can only be used by one QKD exchange at one point in time. The systems and methods described herein model the key rates of a BB84 execution over edge (u, v) as γ_{u,v} and of a MDI-QKD execution over the edges (u, v) and (v, w) as γ_{u,v,w}.

For each round of the key buffering cycle, the controller is given the set of requests R. A secret-key request r∈R stems from the demand of an application to establish an encrypted connection between two nodes inside of a private QKD network, denoted by sᵣ and dᵣ for source and destination. The set of nodes outside of this private network, and therefore must not be a trusted relay for the request, is denoted as μᵣ. Other parameters include κᵣ as the required secret-key size as tr, and as the expiration time window of the request.

To support the time-sharing resource scheme, the time slot model is adopted as the scheduling time unit. The time slot is defined as an interval of smallest granularity in which all steps for a QKD protocol (e.g., qubit exchange, key sifting, key distillation) can be completed. With which, the QKD key rate γ is measured by secret-key size to be established during one time slot. Hence, the duration of a QKD protocol on a relay path of r is can be calculated as:

$$Δ = ⌈ \frac{{k}_{r}}{γ} ⌉$$

wherein Δ expresses the number of time slots the involved QKD resources need to occupy to establish a κᵣ-size secret.

The time line is denoted as T and τᵣ∈T∀r∈R as the collection of time slots that encompasses every the requests expiration windows in a buffering round.

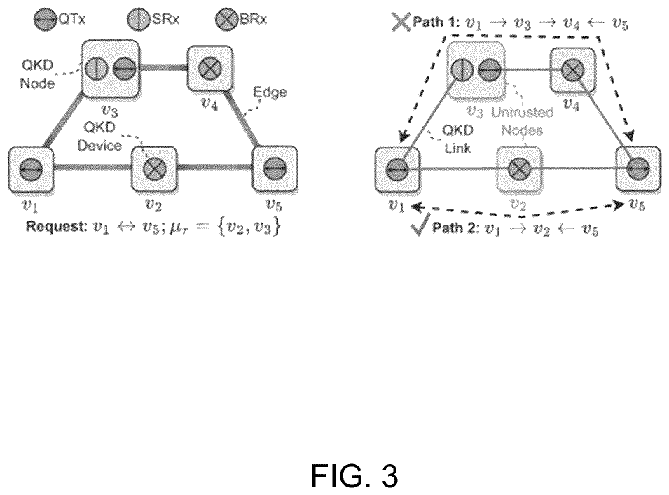

FIG. 3 shows example trustable-aware relays according to the systems and methods disclosed herein. A secret-key is requested between v₁ and v₅ of the circle network. Entities of the square network are listed as untrusted nodes: μᵣ={v₂, v₃}. With the resource status of the network, two relay options are listed: v₁→v₃→v₄←v₅ and v₁→v₂←v₅. In the first path, node v₃ is used as a trusted relay, hence the path is not valid. In contrast, the second path utilizes v₂ as an untrusted relay, and therefore is eligible to serve the request.

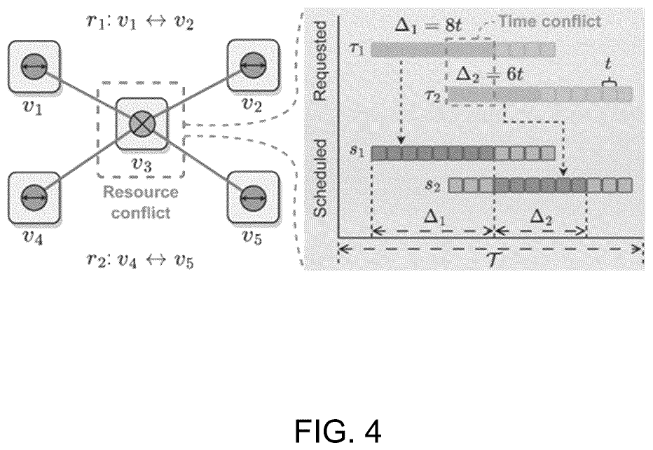

FIG. 4 shows example time-slot allocation according to the systems and methods disclosed herein. There are two requests r₁ and r₂ with the expiration windows of τ₁ and τ₂. The two relay paths for the requests are v₁→v₃←v₂ and v₄→v₃←v₅. Notice that since τ₁ and τ₂ overlapped, there is a resource conflict between two relay paths, in particular, the BRx at v₃ is used by both paths. However, with the durations Δ₁ and Δ₂, the MDI-QKD execution schedule for r₂ can be “slided” forward to work around the conflict. The final scheduling result s₁ and s₂ both facilitate the protocols while staying with in the respective expiration windows. This scheme comprises similarities to the concept of time sliding window (TSW) described in.

$${\text{?}}_{u , υ}^{( r , t )} :$$

$$\text{?} \text{indicates text missing or illegible when filed}$$

decision variable, 1 if the resources [symbol] u,Q [symbol] , [symbol] u−v [symbol] and [symbol] v,S [symbol] are allocated at time slot t∈T for request r∈R, 0 otherwise. If the statement is true, it implies that a BB84 key exchange is assigned for request r at time slot t between two nodes u and v.

$${\text{?}}_{u , υ}^{( r , t )} :$$

$$\text{?} \text{indicates text missing or illegible when filed}$$

decision variable, 1 if the resources [symbol] u,Q [symbol] , [symbol] u−v [symbol] and [symbol] v,B [symbol] are allocated at time slot t∈T to fulfill request r∈R, 0 otherwise. If

$${β}_{u , υ}^{( r , t )} = 1 ,$$

it implies that a MDI-QKD key exchange is assigned for r at t, part of this protocol is executed with qubits transmitted from [symbol] u,Q [symbol] and received by [symbol] v,B [symbol] . If there exists w∈V where

$${β}_{w , υ}^{( r , t )} = 1 ,$$

a full MDI-QKD protocol execution can be confirmed between nodes u and w via v as the untrusted relay.
^{(r)}: decision variable, 1 if request r∈R is fulfilled by the network controller, 0 otherwise.

### Objective

$$Maximize {\sum }_{r ∈ ℛ} {ρ}^{( r )} \qquad ( 1 )$$

At every round of scheduling in the key buffering cycle, the controller looks to allocate QKD resources in such way that fulfills the maximum number of incoming key requests.

### Constraints

### OKD Resource Constraints

$${\sum }_{r ∈ ℛ} {α}_{u , υ}^{( r , t )} + {α}_{υ , u}^{( r , t )} + {β}_{u , υ}^{( r , t )} + {β}_{υ , u}^{( r , t )} \leq \vert {C}_{u , υ} \vert ∀ ( u , υ ) ∈ ε , t ∈ 𝒯 \qquad ( 2 )$$

$${\sum }_{r ∈ ℛ} {\sum }_{( u , υ ) ∈ ε} {α}_{υ , u}^{( r , t )} + {β}_{υ , u}^{( r , t )} \leq \vert {D}_{υ}^{Q} \vert ∀ υ ∈ 𝒱 , t ∈ 𝒯 \qquad ( 3 )$$

$${\sum }_{r ∈ ℛ} {\sum }_{( u , υ ) ∈ ε} {α}_{u , υ}^{( r , t )} \leq \vert {D}_{υ}^{S} \vert ∀ υ ∈ 𝒱 , t ∈ 𝒯 \qquad ( 4 )$$

$${\sum }_{r ∈ ℛ} {\sum }_{( u , υ ) ∈ ε} \frac{{β}_{u , υ}^{( r , t )}}{2} \leq \vert {D}_{υ}^{B} \vert ∀ υ ∈ 𝒱 , t ∈ 𝒯 \qquad ( 5 )$$

Equation (2) ensures that the QKD link resources allocated for the requests on an edge do not exceed capacity at any point in time. In the same manner, equations (3), (4) and (5) ensure that the QKD devices assigned on each node also do not exceed the capacity of the node.

### Time Window Constraint

$${\sum }_{\text{?}} {\sum }_{( u , υ ) ∈ ε} {α}_{u , υ}^{( r , t )} + {β}_{u , υ}^{( r , t )} = 0 ∀ \text{?} ∈ ℛ \qquad ( 6 )$$

$$\text{?} \text{indicates text missing or illegible when filed}$$

Equation (6) ensures that the resources for request r be allocated only within the time window tr.

### Path Constraints

$${\sum }_{\text{?}} \text{?} + \text{?} + \text{?} \leq 1 ∀ \text{?} ϵ ℛ , t ϵ 𝒯 \qquad ( 7 )$$

$${\sum }_{\text{?}} \text{?} + \text{?} + \text{?} \leq 1 ∀ \text{?} ϵ ℛ , t ϵ 𝒯 \qquad ( 8 )$$

$${\sum }_{\text{?}} \text{?} + \text{?} + \text{?} - {\sum }_{\text{?}} \text{?} + \text{?} + \text{?} = 0 \qquad ( 9 )$$

$$∀ \text{?} ϵ ℛ , t ϵ 𝒯$$

$${\sum }_{\text{?}} \text{?} - {\sum }_{\text{?}} \text{?} = 0 \qquad ( 10 )$$

$$∀ \text{?} ϵ ℛ , t ϵ 𝒯 , v ϵ 𝒱 , u \neq w$$

$$\text{?} \text{indicates text missing or illegible when filed}$$

Equations (7), (8) and (9) ensure that there can only be at most one relay path per one request. Equation (10) ensures that the resources are assigned properly for any MDI-QKD protocol that use v as the untrusted relay.

### Trustable Relay Constraint

$${\sum }_{\text{?}} {\sum }_{\text{?}} {\sum }_{\text{?}} \text{?} + \text{?} + \text{?} = 0 \qquad ( 11 )$$

$$∀ \text{?} ϵ ℛ$$

$$\text{?} \text{indicates text missing or illegible when filed}$$

Equation (11) ensures that the QTxs and SRxs on the untrusted nodes of a request will never be allocated for its relay. Since usage of these devices implies that the node is being used as trusted relay.

### Key Size/Protocol Duration Constraints

$${\sum }_{\text{?}} \text{?} \geq \text{?} ∀ \text{?} ϵ ℛ , ( u , v ) ϵ ℰ \qquad ( 12 )$$

$${\sum }_{\text{?}} \text{?} \geq \text{?} \qquad ( 13 )$$

$$∀ \text{?} ϵ ℛ , ( u , v ) , ( u , w ) ϵ ℰ$$

$$\text{?} \text{indicates text missing or illegible when filed}$$

Equation (12) ensures that for a request r to be fulfilled, each assigned BB84 protocol on its relay path is executed in sufficient time slots duration to establish a secret-key size κᵣ. The same enforcement to the MDI-QKD protocols on the relay path is described in equation (13).
Theorem 1: When there is only one relay path for each source-destination pair on the graph, the TRP problem is NP-hard.

Presented below are two different resource scheduling models and discussion of the routing metrics of the proposed algorithms.

### Device-to-Device Path Finder

A regular shortest path algorithm, e.g., Dijkstra or BFS, visits the graph node-by-node via the edges. The algorithm proposed herein (conflict-free routing and scheduling at runtime (CRSR)) visits the graph device-by-device via the channels and protocol types. The use of [symbol] v,x [symbol] herein is to denote a device, and can indicate any of QTx, SRx or BRx, at node v∈V with x∈{Q,S,B}, respectively. To keep track of the visit, the set V of visited devices is defined by the path finder, and

$${χ}_{υ}^{x}$$

for the prospective occupied resource of the visit to [symbol] v,x [symbol] . The pseudo-code in Algorithm 2 (eBFS) demonstrates a path finder variation with BFS as the shortest path utility. Similar approach can be taken with the Dijkstra variation for TLen.

### Scheduling Resources on a Path

An algorithm may examine the availability and detect conflict of resources between selected paths and potential route. The systems and methods described herein may keep track of a components occupation set O, which may comprise

$$\{ {ζ}_{v}^{Q} , {ζ}_{v}^{S} , {ζ}_{v}^{B} \vert ∀ v ∈ 𝒱 \}$$

as the set of occupied QTx, SRx, BRx consecutively at node v, and similarly {ζ_{u,v}|∀(u,v)∈E} as set of occupied channel on edge (u,v). The path selection models and algorithms described herein may be based on the resource recording and searching defined herein. There are three types of resource searching operations (λ): 1) λ₁ (u,v), BB84 protocol between u and v, in which the occupation will be among

$$\{ {ζ}_{u}^{Q} , {ζ}_{u , v} , {ζ}_{u}^{S} \} ; 2 ) {λ}_{2} ( u , v ) ,$$

untrusted node preliminary search among

$$\{ {ζ}_{u}^{Q} , {ζ}_{u , v} , {ζ}_{u}^{S} \} ; 3 ) {λ}_{3} ( w , u , v ) ,$$

MDI-QKD protocol between w and v with untrusted intermediate node u, among {ζ_{wQ}, ζ_{w,u}, ζ_{uB}, ζ_{w,u}, ζ_{vQ}}.

### Time Slot Model

A four phase model of entanglement routing to produce pairs of entangled qubits between two nodes on the network is known. This model is proven to be useful in scheduling concurrent resource for entanglement swapping. However, the duration of time slot in this model is extremely short in order to deal with the entanglement de-coherence. Therefore, instead of applying this on a Software-defined Networking platform, each node calculates and executes the routing with limited degree of visibility on the overall network, since there is not enough time to populate the routing result between the nodes. The network model proposed herein employs only prepared and measure QKD protocols, hence the model can deploy the routing algorithm on an SDN controller, extend the time slot duration and have the routing result synchronized to every nodes.

The modified time slot model described herein includes three phases. Phase one, the SDN controller collects the requests that have the required time window crossover with the time slot. This means that at time slot t a request r with the required time window τᵣ=(x_{τ}, y_{τ}) can be collected if t>x_{τ} and t<y_{τ}. Phase two, the SDN controller runs the algorithms to calculate the secret relay paths for each individual requests along with the resources needed. Phase three, the routing result is synchronized across the network and the secret establishment between the source and destination of each routed request would be executed by the nodes per the controller instruction.

In a particular time slot, the occupation status of a component is tracked with ζ, the number of resources that has been assigned to the key exchanges. By this design, ζ_{u,v} tracks the number of assigned channels on edge (u, v), and

$${ζ}_{v}^{Q} , {ζ}_{v}^{S} , {ζ}_{v}^{B}$$

tracks the number of assigned QKD devices at node v. The resource searching operation (λ) determines the availability of the channels and devices by comparing them to |C_{u,v}| and

$$\vert {D}_{v}^{Q} \vert , \vert {D}_{v}^{S} \vert , \vert {D}_{v}^{B} \vert ,$$

respectively.

### Time Window Model

A time window model may be used in order to determine whether a given path can be selected to fulfill a key request. A determination may be made of if the nodes and the edges on the path has the resources available during the required time window to facilitate all the protocols on the path. Disclosed herein is an algorithm to search for aligned available resources schedules, which can also be applied to check for next available hops in a path finding algorithm.

For each key exchange taking place between two nodes on a path and based on the key rate and number of requested key of the connection(s), the duration δ of the protocol hence resource occupation may be calculated. All relevant components that facilitate the protocol must be available and occupied at the same time frame (t,t+δ)∈τᵣ, which also needs to be fit into the required time-window of the key request. Depending on the types of protocol and path relaying model, the relevant components might vary.

To track resource assignment in this model, the dimension of time must be introduced. Instead of

$$\{ {ζ}_{u , v} , {ζ}_{u}^{Q} , {ζ}_{u}^{S} , {ζ}_{u}^{B} \}$$

tracking number of assigned resources of a component in one time slot, each node contains a set of ★C_{u,v}|:

$$\vert {D}_{v}^{Q} \vert , \vert {D}_{v}^{S} \vert , \vert {D}_{v}^{B} \vert$$

resource occupation schedule throughout the timeline T of the scheduling cycle. Each schedule is a series of ordered, non-overlapping time frames

$$ζ = \{ ( {x}_{1}^{ζ} , {y}_{1}^{ζ} ) , ( {x}_{2}^{ζ} , {y}_{2}^{ζ} ) , … , ( {x}_{η}^{ζ} , {y}_{η}^{ζ} ) \}$$

already assigned to other requests.

In order to determine an eligible time frame of a component, a set of gaps

$$σ = \{ ( 0 , {x}_{1}^{ζ} ) , ( {y}_{1}^{ζ} , {x}_{2}^{ζ} ) , … , ( {y}_{η}^{ζ} , \vert 𝒯 \vert ) \}$$

may be constructed between occupied time frames. Consider a time gap σ=(x_{σ},y_{σ}) with regards to the required time window τ_{τ}=(x_{τ},y_{τ}), overlapping time window ω, with x_{ω}=max(x_{σ},x_{τ}) and y_{ω}=min(y_{σ},yₜ), may occupy request r if x_{ω}+δᵣ<=γ_{ω}. m sets {ξ₁, ξ₂, . . . , ξₘ} may be collected, each set

$${ξ}_{i} = \{ {ω}_{1}^{i} , {ω}_{2}^{i} , … \}$$

contains all the time windows of a component that is eligible for occupation.

Algorithm 1 describes the steps to extract the first an eligible time frame across all the components.

Algorithm 1 Resource schedule search for protocol

```
Input: Protocol resource, network resource status, protocol
          duration (Δ)
Output: Protocol execution time window
  1: I ← an array of m unoccupied iterators, all set to 1
  2: while True do
  3: j ← null
  4: for i = 1 to m do
  5: if I[i] + 1 > |ξᵢ| then
  6: continue
  7: if j = null then
  8: j = i; continue
  $9 : ( {x}_{i} , {y}_{i} ) = ω \text{?} , ( {x}_{j} , {y}_{j} ) = ω \text{?}$
10: if xᵢ < xⱼ or (xᵢ = xⱼ and yᵢ < yⱼ) then
11: j = i
12: if j = null then
13: return null
14: // Increase the iterator
        I[j] ← I[j] + 1
$15 : // Find a time frame fit within {τ}_{r} ⋂ \{ ω \text{?} \vert ∀ i ∈ [ 1 , m ] \}$
16: (x_{c}, y_{c}) ← [symbol]
17: for i = 1 to m do
$18 : ( {x}_{i} , {y}_{i} ) = ω \text{?}$
19: x_{c} ← max (x_{c}, xᵢ), y_{c} ← min (y_{c}, yᵢ)
20: if x_{c} + δ ≤ y_{c} then
21: return (x_{c}, x_{c} + δ) [symbol]
indicates data missing or illegible when filed
```

### Routing Metric

Besides obeying the requirements of time window, number of keys and skipping over the untrusted repeaters, in order to efficiently complete fulfilled requests, the resource dedicated for a relay path may be cost effective. The metric may be defined by comparing the quality of the routing path in a network model as total channel and device occupied time slots for each request r.

To reduce the complexity of the original routing metric, two approximations may be considered.

### Total Path Length(TLen)

With l_{u,v} as the optical fiber length of edge (u,v), for a request r,TLen is computed as

$${\sum }_{( u , v ) ∈ ε} ( {a}_{u , v}^{( r )} + {b}_{u , v}^{( r )} ) {l}_{u , v} .$$

The idea behind minimizing the path distance is that each individual key exchange on the path will have higher key rate, hence will occupy less time slots and minimize the overall resource consumption (see equation (14)).

$${\sum }_{t ∈ T} {\sum }_{\text{?}} \text{?} + \frac{5}{2} β \text{?} \qquad ( 14 )$$

$$\text{?} \text{indicates text missing or illegible when filed}$$

### Number of Hops (NHop)

Formally defined as

$${Σ}_{( u , υ ) ∈ ε} {a}_{u , υ}^{( r )} + {b}_{u , υ}^{( r )} .$$

In minimizing NHop, the number of components consumed in a path may be reduced, hence reduce the amount of channels and QKD devices being occupied for a request and reduce the overall resource consumption.

### Request Priority

The request priority refers to the order a request is attempting to be served. To increase the amount of requests served, the requests with the lowest number of required key may be prioritized first. In that way, the duration of resource consumption may be decreased.

### Offline Routing Runtime Scheduling (ORRS)

An offline routing runtime scheduling (ORRS) algorithm was considered. The ORRS algorithm may prepare many possible routing paths, sorted by routing metrics. In runtime, paths are tried out individually in the routing metrics order. If all of the components on the path can be searched for possible schedules within the required time window, then the path is selected. The idea is to save time by separating the path finding step (pre-computation) from the components schedule search step (tryout selection).

### Pre-Computation

The pre-computation portion of the algorithm is carried out by receiving key requests and the topology in the beginning of a buffer cycle. A set of P of k-shortest paths may be calculated for each distinct pair of source and destination S-D. The pre-computed paths may be associated with the requests with the matching S-D pair. In order to discover the set P, Yen's algorithm may be used and built on top of Dijkstra, as the shortest path finder. The algorithm may rank the order of the route variations based on TLen metrics. For NHop metrics, the algorithm may comprise a small modification by replacing Dijkstra with BFS as the shortest path algorithm.

### Tryout Selection

The tryout selection portion of the algorithm takes place after the completion of the pre-computation. For the time schedule model, the tryout selection portion only needs to run once in a set time period. The tryout selection portion may be repeated through every time slot in the buffer cycle. By running selectively over a time period, the system has the advantage of instant detection of resource contention, while running the portion at every time slot in a buffer cycle needs to apply the component schedule search in order to do the same thing. The tryout selection portion comprises three steps.

### Step 1

Initiate the resource occupation set O=Ø.

### Step 2

For each k-shortest path set Pᵣ={ρ₁,ρ₂, . . . } of request r, find the first path ρᵣ with no resource contention.

### Step 3

Select path ρᵣ to assign resource for request r and add the resource occupation to O.

Regarding Step 2, for a candidate path ρ_{c}={v₁, v₂, . . . }, protocol tryouts may be conducted for each hop. Assuming a resource is sufficient from v₁ to vᵢ, the algorithm may find resources to relay to the next nodes on the path.

### Conflict-Free Routing and Scheduling at Runtime (CRSR)

Instead of trying out the routes and checking if there are conflicts in resources of the selected paths, resource conflict avoidance is built in to the CRSR algorithm. In short, the algorithm goes through each request while maintaining the set of occupied resources O. Algorithm 2 below shows a CRSR created to exhaust the unoccupied resources and find a relay path. If a path discovered, then update the path resource to the set O.

Algorithm 2 Path finder (eBFS)

| Input: Network topology, request specification, current | |
|---|---|
| | resource utilization status |
| Output: Assigned relay path and QKD resources | |
| 1: | Let Q be BFS queue, it is initialized with the source |
| | device, i.e. the QTx device at source node: Q ← {( [symbol] , Q)} |
| 2: | Let R [symbol] be the resource selected for visiting ( [symbol] , Q), |
| | it is set to empty: R [symbol] ← ∅ |
| 3: | Let V marks the visited devices, the trusted devices at |
| | source node is marked as visited: V [symbol] , V [symbol] ← true [symbol] |
| 4: | while Q ≠ ∅ do |
| 5: | (v, x) ← de [symbol] queued from Q |
| 6: | for (v, u) ∈ E do |
| 7: | Let Zₓ be possible QKD devices at u that can |
| | be visited from (v, x), the set is determined by x as: |
| | Zₓ [symbol] = {Q, [symbol] , B}, Z [symbol] = {Q} |
| 8: | for [symbol] ∈ Zₓ do |
| 9: | Let λ [symbol] be the QKD resources sufficient to visit |
| | (u, z) from ( [symbol] , x). |
| 10: | if [symbol] V [symbol] and λ [symbol] ≠ null then |
| 11: | R [symbol] ← R [symbol] ∪ λ [symbol] |
| 12: | if u = d [symbol] and z ∈ {Q, S} then |
| 13: | return R [symbol] |
| 14: | V [symbol] ← true |
| 15: | Q ← Q [symbol] enqueue((u, z)) |
| 16: | return null |

[symbol]

indicates data missing or illegible when filed

With an available channel (u,v), from the visits of [symbol] u,S [symbol] (complete of a BB84 exchange) and [symbol] u,Q≡ (complete of an MDI-QKD exchange) there are two options for the next visits: [symbol] v,S [symbol] , starts a new BB84 protocol communication path that finishes at v, or [symbol] v,B [symbol] , starts a new MDI-QKD protocol communication path with v as an intermediate. From the visit of [symbol] u,B [symbol] , there is only one option to finish the MDI-QKD protocol at [symbol] v,Q [symbol] , for a hop through a trusted node that is eligible to route through all three devices of this node. Conversely, for an untrusted node u∈μᵣ, only the visit of [symbol] u,B [symbol] is available, routing through [symbol] u,S [symbol] and [symbol] u,Q [symbol] is disabled since QTX and SMD are both trusted components.

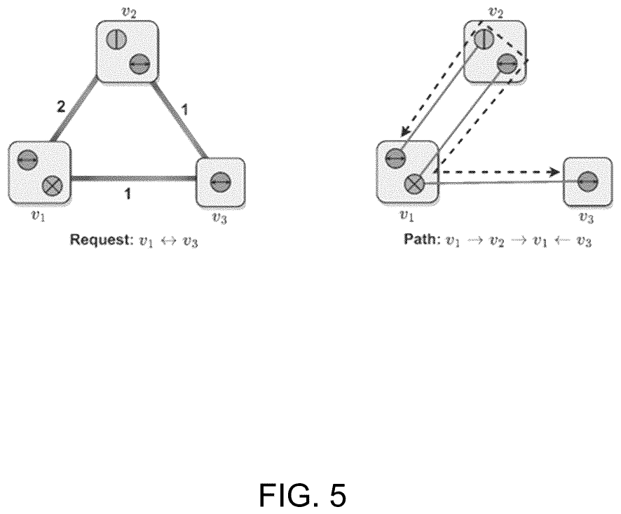

FIG. 5 demonstrates the exhaustiveness of the device-to-device path finder. With a standard node-by-node routing algorithm, it is impossible to find a secret relay path between v₁ and v₂, since neither one of them have an SMD to facilitate a BB84 protocol on the direct connection (v₁, v₂). However, with device-to-device routing, the secret can be relayed to [symbol] v₂,S [symbol] using BB84, and then to [symbol] v₃, Q [symbol] with MDI-QKD via the [symbol] v₁,B [symbol] device.

### Protocol Simulation

Below describes methods utilized to model a hybrid network with the NetSquid simulation library. The methods employed the Qiskit library (provided by IBM) to design and test the necessitated gate-based quantum circuit.

### BB84L Single-State Simulation

The BB84 protocol simulation used was based on the work in “Benchmarking of quantum protocols,” Scientific reports, vol. 12, no. 1, pp. 1-13, 2022. The modeling provided by NetSquid of quantum and classical channels was used to simulate the photon transmission delay. The modeling provided by NetSquid of qubits and measurement in the basic quantum computation functionality was used to simulate the polarized photon at the transmitting end and observation at the receiving end. The modeling of nodes and ports supports the ability to manage the components, while the ‘protocol’ class based on the PyDynAA software library helps organize the event-driven QKD protocol. Two nodes were simulated: Alice and Bob. Alice generated qubits and applied quantum operation to manipulate the qubits randomly into one of the four states {|0), |1), |+), |−)}, and transmitted the qubits via the quantum channel to Bob. Bob listened on the quantum channel port for incoming qubits, then applied the measurement operations to the qubits in one of two randomized bases {Z,X}.

### MDI-QKD: Analysis of Bell-State Projection

While a BB84 single-state measurement device can be simulated via Netsquid with basic qubit measurement, the simulation of a Bell-state projection device is not as straightforward. Instead of the measurement device making observations of one photon at a time, in MDI-QKD, two-photon correlation observations are made. To accurately replicate the behavior of a BPD, the possible scenarios of two photons randomly polarized in four direction {|0>, |1>, |+>, |−>} and associated Bell-state projection results {ψ⁻, ψ⁺, null}, with null being an unsuccessful measurement was considered, and the probability of occurrence associated with each was calculated, excluding the photon pairs that are not in the same basis.

The Bell-state projection was carried out with optical set up of a beam splitter (BS), two polarizing beam splitters (PBS), and a photon detector at outputs. To precisely simulate the measurement of the BPD, inspection and establishment of the possibilities of measurement results in each possible same-basis photons preparation scenarios was performed. Considering the rectilinear basis, there are two possible photon states to be measured. First, the polarization of two photons was orthogonal, in which case they were either split at the BS and detected as a ψ⁻ event, or exited on the same output arm and detected as a ψ⁺ event-both events had a 50% likelihood of occurrence. Second, the polarization of two photons was identical, both of the photons either hit horizontal detector {D1H,D2H} or vertical detector {D1V,D2V} in a single measurement event—the probability of unsuccessful measurement in this case was 100%. Considering the diagonal basis, in the case of identically polarized photons, the Hong-Ou-Mandel effect is applied at the Beam Splitter. Table II summarize the possible same-basis photon states and their probability of different measurement results.

TABLE II
BRX INPUT/OUTPUT ANALYSIS

| Prepared photon states | | | Relay output probability | | |
|---|---|---|---|---|---|
| Basis | Correlation | Polarization | null | Ψ⁻ | Ψ⁺ |
| Rectilinear | Identical | \|0 [symbol] ⊗ \|0 [symbol] | 100% | 0% | 0% |
| | | \|1 [symbol] ⊗ \|1 [symbol] | | | |
| | Orthogonal | \|0 [symbol] ⊗ \|1 [symbol] | 0% | 50% | 50% |
| Diagonal | Identical | \|+ [symbol] ⊗ \|+ [symbol] | 50% | 0% | 50% |
| | | \|− [symbol] ⊗ \|− [symbol] | | | |
| | Orthogonal | \|+ [symbol] ⊗ \|− [symbol] | 75% | 25% | 0% |

### Qiskit: Gate-Based BRx Simulation

To model the BPD accurately following the scenarios analysis described above, a gate-based quantum circuit with NetSquid-provided basic quantum gates was designed: Hadamard (H), NOT (X), CNOT (CX) and double-CNOT (CCX). The circuit produced Bell-state results with the input of two photons represented by q₀ and q₁. Qubit q₂ was wired to detect whether q₀, q₁ were identical regardless of their polarization bases (photon pairs polarized in the same basis were considered). Qubits q₃₋₅ were employed to set the weights of randomness, with q₃ and q₄ at the 50:50 and q₅ at the 75:25 randomization of {|0 [symbol] , |1 [symbol] }. Qubits q₆₋₉ were wired to produce the BPD relay output and were readout respectively to the classical bits c₀₋₃. Once the circuit was executed, the state of c_{0,1} signified the relay output of ψ⁻ and ψ⁻ if q_{0,1} was prepared in a rectilinear basis. Similar description applied with c_{2,3}, representing ψ⁺ and ψ⁻ for the input qubits prepared in diagonal basis.

Results from a Qiskit simulation of the BPD circuit with the prepared input qubits may be shown in a) identical rectilinear, b) orthogonal rectilinear, c) identical diagonal, d) orthogonal diagonal.

### Qiskit Circuit

To display the precision of the BPD quantum circuit described herein, the BPD quantum circuit was implemented on Qiskit, an IBM powered open-source quantum software development kit, and employed Qiskit Aer to simulate the circuit execution. Only the readout of c_{0,1} with rectilinear input qubits and c_{2,3} with diagonal input qubits were plotted. To increase the accuracy of testing, the number of measurement trials was set to 16384 (2¹⁴) times.

### Key-Rate Benchmark

Based on the analysis of the above described research, a Netsquid simulation was built for the BB84 and MDI-QKD protocols.

The key rate may be benchmarked against total channel distance of each protocol. The protocols were run over various channel distances L ranging from 10 km to 200 km. BB84 requires only one fiber from Alice to Bob, while with MDIQKD, the channels from Alice and Bob to Charles are set up symmetrically, each with the length of L/2. Results show that within the same total distance, the BB84 protocol has a higher key rate than MDI-QKD by a quite significant margin. This is partly due to the lower rate of successful bit agreement of MDI-QKD (21.875%) compared to that of BB84 (50%), and partly due to the higher amount of classical communication required in MDI-QKD.

The impact of channel asymmetry may be demonstrated on the key rate of MDI-QKD. The protocol was instantiated over a fixed total channel distance of 20 km with the asymmetry ratio ranges between 1:1 and 1:31. The result shows a quite substantial decline at the beginning where the asymmetry ratio is at 1:3, 1:5 and 1:7, however, the differences become trivial as the asymmetry ratio grows from 1:15 to 1:31.

When considering algorithms, going through a list of routing options may be as resource intensive as routing with a simple resource check.

In an aspect, the QCAST algorithm may be considered for the time slot processing cycle of metric TLen.

### APPENDIX

Advancements of Joint BB84-MDI Quantum Key Distribution: Architecture, Protocol, and Evaluation

Akin to classical internet, as the quantum key distribution (QKD) network increases in scale, one of its key functionalities is to distribute secret keys across multi-hop while dealing with both trusted and untrusted nodes. BB84 and MDI are two well-studied and widely used QKD protocols, each with distinct applications in trusted relay and untrusted relay QKD network models, offering different performance advantages in terms of key generation rate and scalability. This work advocates for a technically-sound yet practical framework for joint BB84-MDI QKD, dubbed Hybrid QKD Protocol (HyPr-Q) that ties both protocols together. In addition to the HyPr-Q architectural design, the present disclosure formulates the problem of SLOs-constrained Optimal end-to-end Hybrid-QKD (SOHQ), whose primary objective is to maximize the number of demands at which their service-level objectives (SLOs) are met while their end-to-end (e2e) QKD paths are constructed using the joint BB84-MDI QKD. Two approaches are proposed, for example, to tackle SOHQ that focus on optimizing two distinct phases of the QKD process: 1) the protocol-link pre-construction phase and 2) the key distribution routing phase to maximize the e2e QKD throughput while carefully considering the SLOs and deployment cost. A comprehensive benchmarking was conducted of the proposed architecture and algorithms through the quantum network simulator, NetSquid. The results demonstrate the high potential and promising outcomes of joint BB84-MDI QKD.

Multi-hop Quantum Key Distribution (QKD). QKD utilizes quantum physical phenomena to guarantee the security of the exchanged cryptographic keys. When the network scale increases, multi-hop QKD addresses the long-distance challenge by enabling quantum communication to be relayed through intermediate nodes. There has been progress in the development of entanglement-swapping-based QKD. These protocols utilize the concept of entanglement swapping and employ a series of quantum repeaters to enable multi-hop entanglement, enabling long-distance QKD]. However, one major obstacle in adopting this technology is the current inefficiency of quantum memory, rendering it impractical for deployment. In contrast, BB84 & MDI-QKD have emerged as robust protocols, demonstrating readiness for in-field deployment despite the recent inception.

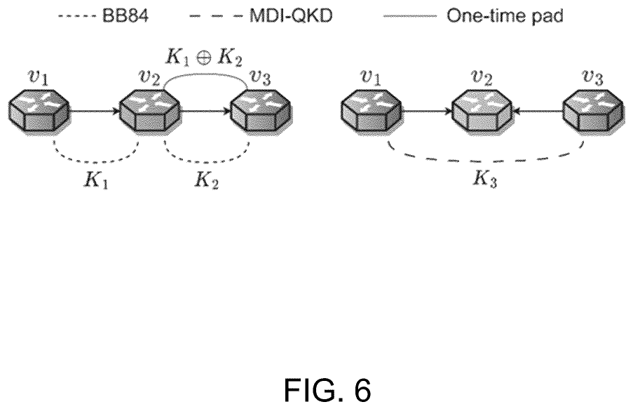

Trusted vs. untrusted relay. FIG. 6 illustrates two compelling approaches in multi-hop QKD for establishing a secure secret-key from v₁ to v₃ via the intermediate node v₂. In the trusted relay method (FIG. 6), v₂ establishes secret-keys with both end nodes using the BB84 protocol [11]. Subsequently, the secret-key (K₁) established with one end (v₁) is encrypted using the unbreakable one-time pad (OTP) method (K₁⊕K₂) [12], and this encrypted key is transmitted to the other end (v₃). FIG. 6. Multi-hop QKD with intermediate node implementing: (a) one-time pad (OTP) trusted relay, and (b) MDI-QKD measurement untrusted relay. In contrast, the untrusted relay method employs the MDI-QKD protocol (FIG. 6), where v₂ acts as an independent measurement party, thereby ensuring that the secret-key remains unknown to the intermediate node.

BB84 vs. MDI-QKD. BB84 protocol offers higher key generation rate in a short-distance key distribution because in BB84, with shorter distances, the probability of photons reaching the receiver intact is higher. However, BB84 enables multi-hop QKD with only trusted relay nodes. Meanwhile, MDI-QKD tends to have lower key generation rates compared to BB84 due to the increased complexity and overhead. However, MDI-QKD eliminates the need for trust in the relay nodes used in the key generation process. In addition, the distance of photon transmission in MDI-QKD is cut-in-half at the intermediate node. Thus, MDI-QKD can achieve better key generation rates over longer distances.

In large-scale QKD both trusted and un-trusted nodes are involved, the combination of MDI and BB84 holds the key to unlocking maximum performance efficiently. Characteristics are summarized as follows:

| | | | Joint BB84- |
|---|---|---|---|
| Characteristics | BB84 | MDI | MDI |
| Trusted relay | ✓ | | ✓ |
| Un- trusted relay | | ✓ | ✓ |
| Best key generation | Short | Long | Short & long |
| rate | distance | distance | distance |
| when both ends are | | | |
| in | | | |

This disclosure presents an innovative framework that seamlessly integrates both BB84 and MDI-QKD, capitalizing on their respective strengths to create a powerful and secure quantum network of the future.

Architectural Design: the disclosure proposes the-first-of-its-kind practical framework for joint BB84-MDI QKD, dubbed Hybrid QKD Protocol (HyPr-Q). The framework will pave the way for embracing both trusted and untrusted relays in quantum communications. Moreover, the practical model of joint BB84-MDI proposed in this study will lay a strong foundation for the future advancement of large-scale QKD.

Problem Formulation: the disclosure formulates the problem of SLOs-constrained Optimal end-to-end Hybrid-QKD (SOHQ). SOHQ aims to maximize the number of demands at which their service-level objectives (SLOs) are met while their e2e QKD paths are constructed using joint BB84-MDI QKD. This optimization takes into account various constraints, including limited network resources, coexistence of both trusted and untrusted nodes, and the e2e key-rate threshold.

Approach: two approaches, for example, are proposed to tackle the SOHQ. These approaches aim to optimize two distinct phases of the QKD process: 1) the protocol link pre-construction phase using hierarchical structure and 2) the key distribution routing phase using “on-the-fly” routing approximation computation to maximize the number of fulfilled demands while carefully considering the SLOs and deployment cost.

Protocol realization and benchmarking: the disclosure provides a first design of the-first-of-its-kind quantum circuit to emulate the behavior of MDI-QKD measurement rigorously verified using IBM Qiskit. Specialized quantum network simulator modules are provided by leveraging the NetSquid library for: 1) realizing the joint BB84-MDI QKD and 2) enabling a comprehensive validation of the proposed HyPr-Q. The present disclosures benchmark the performance of the proposed algorithms in terms of QKD efficiency, particularly focusing on the success of key-rate delivered through e2e QKD.

Organization. In § II, The present disclosures discuss the importance of quantum networking and a vision for its future development. In § III The present disclosures propose the HyPr-Q architecture as well as present its implication and operation. The present disclosures formulate the SOHQ problem in § III-B and propose two approaches to tackle this problem in § IV and § V. In § VI the present disclosures present the simulation of the HyPr-Q network via NetSquid and Qiskit. The present disclosures provide the algorithm evaluation results in § VII and conclude this work in § VIII.

Post-quantum cryptography (PQC) has emerged as a promising approach to address the potential threats posed by quantum computing to classical cryptographic systems. However, it is crucial to recognize that QKD remains of utmost importance in the domain of secure communication.

Is PQC alone enough for quantum-resistant security? PQC is a software-based approach that employs cryptographic algorithms to ensure quantum-resistant security within the current Public Key Infrastructure (PKI). The effectiveness of PQC hinges on safeguarding the Certificate Authority (CA). However, what if the CA is compromised by other means? Once the master key of a CA is publicly exposed (e.g., due to human-error), it poses a significant risk to the security of all previous communications that were certified by this CA.

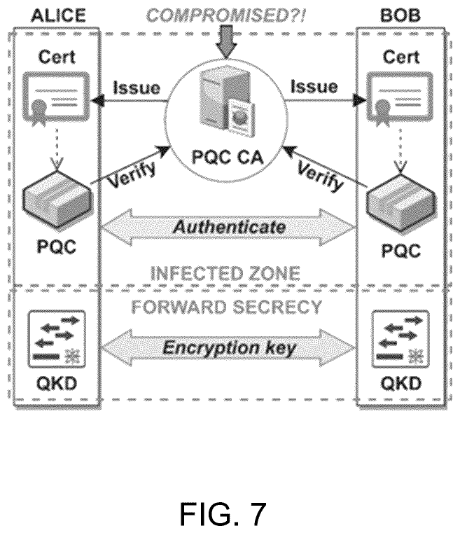

FIG. 7 illustrates the seamless Resolution of the compromised CA issue through the integration of QKD with PQC. In this setup, the PQC-upgraded PKI plays a crucial role in initiating the authentication process for the QKD substrate. The incorporation of PQC cryptosystems ensures effective protection against real-time attacks emanating from quantum computers. FIG. 7 shows a PQC-integrated QKD model. After a secure QKD exchange, a mutual encryption key is established between the communicating parties, ensuring that even if the PQC-CA is compromised in the future, the encryption key remains undisclosed and secure from unauthorized access.

QLAN: Similar to the classical Internet's local area network (LAN) that are usually owned, controlled, and managed by a single organization or individual, ensuring secure communications. This trust-based model carries over to the quantum LAN (QLAN) using the BB84 protocol.

QWAN: Akin to wide area network (WAN) in classical Internet, the integration of BB84-MDI QKD enables a shift from QLAN to the quantum WAN (QWAN). QWAN facilitates collaboration and data exchange between different quantum nodes beyond the boundaries of individual QLANs, promoting the interconnected quantum communication.

### Preliminaries: Architecture, System Model, and Problem Formulation

The present disclosures introduce the Hybrid QKD Protocols (HyPr-Q) architecture for the QWAN and use simple examples to present the key ideas behind our proposed paradigm in § III-A. The present disclosures then present a general problem formulation and highlight major objectives in § III-B. the present disclosures propose the SLOs-constrained Optimal end-to-end Hybrid-QKD (SOHQ) problem. The primary objective of SOHQ is to maximize the number of demands at which their service-level objectives (SLOs) are met by the end-to-end (e2e) QKD constructed through the joint BB84-MDI QKD.

### Architecture and System Model of Joint BB84-MDI QKD

HyPr-Q architecture. The HyPr-Q network is composed of multiple interconnected QLANs.

The network is given as G(V, E, R) where V denotes the set of nodes [(each node belongs to one of the QLANs), let us denote S (u) as the QLAN that contains node u∈V. A node v∈V is considered trusted by u if they belongs to the same QLAN, i.e. V^{u}=V^{v}, otherwise, v is considered untrusted by u.] E denotes the set of links connecting the nodes, [there are two types of links, intra-fibers, connecting two nodes within a QLAN, and inter-fibers connecting two nodes from different QLANs. The fiber links facilitate the transmission of qubits, which allows for the protocol setups with devices among the nodes] In addition, R denotes the set of QKD resources in the network. The present disclosures advocate for the first-of-its-kind architecture for quantum nodes in HyPr-Q, in which each node v is equipped with a limited number of quantum devices such as Quantum Transmitter (QTx), Single-state Receiver (SRx), and Bell-state Receiver (BRx). The present disclosures denote the specific device QTx, SRx, and BRx at node v as [v, Q], [v, S], and [v, B], respectively. This design empowers nodes in the HyPr-Q network with sufficient capability to handle both BB84 and MIDI-QKD protocols. In particular, QTx is responsible for generating and sending qubits to the other end-node while SRx receives the qubits from the other end-node and measures them in the appropriate bases. The measurement outcomes are then used to establish the shared secret key. BRx is used in MDI-QKD as an independent device at the relay nodes to measure the correlation of the qubit pairs that are transmitted by two end-nodes. The measured correlation is then used by the end-nodes to interpret the secret key. [The present disclosures use the notations R^{Q}, R^{S}, R^{B} to denote the limited numbers of QTx, SRx, and BRx devices at node v.]

Key-rate and e2e key-rate. QKD is a quantum cryptographic protocol that enables the secure exchange of encryption keys between two parties. Hence, each source-destination pair, (s, d) requires a specific key-rate, γ_{(s,d)} to meet the security and performance requirements of the applications running at their respective ends s and d. In particular, the key rate represents the rate at which secure keys can be generated and exchanged between communicating parties. Obviously, the e2e key rate in a QKD network is affected by the key rate of the key distribution links that constitute the network. Specifically, the creation of multi-hop QKD involves establishing secure QKD links between adjacent nodes. Key exchange occurs between neighboring nodes, and the keys are then relayed (e.g., using BB84 or MDI-QKD) to extend secure communication. Therefore, it is crucial to optimize the performance of each QKD link and select appropriate protocols to achieve the desired e2e key rate for secure and efficient quantum communication across the network. This is also the central research challenges tackled in this work.

Quantum protocol-link. Each key distribution link in the network requires specific quantum devices at each end-node, and the type of devices used depends on the QKD protocol being employed, such as BB84 or MDI-QKD. The present disclosures advocate for a new term, quantum protocol-link that indicates the specific requirements for the quantum devices used at each end-node to implement the key distribution link. For instance, a BB84 protocol-link (u, v), requires one QTx at u denoted as [u, Q] and one SRx at v denoted as [v, S]. Likewise, in a MDI protocol-link denoted as (u, w, v), one QTx, one SRx, and one BRx are required at u, v, and w, respectively. The present disclosures denote the set of all possible BB84 and MDI protocol-link as L. [Due to the trust among nodes limited only within QLAN, we have that (u, v)∈L and (u, w, v)∈L if and only if V^{u}=V^{v}.] The present disclosures denote the key-rate of BB84 and MDI protocol-link as γ_{(u,v)} and γ_{(u,w,v)}, respectively.

### SLOs-Constrained Optimal End-to-End Hybrid-QKD

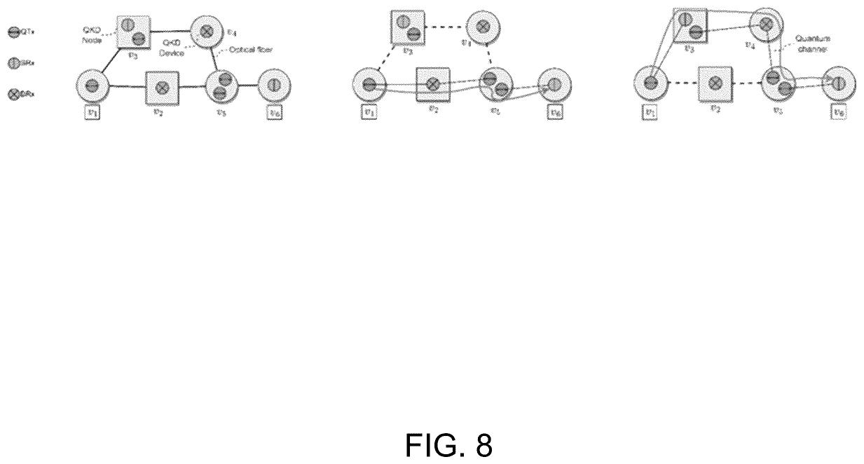

Clearly, constructing e2e QKD will hinge on the set of quantum protocol-link deployed from s to d. FIG. 8 shows an example of e2e QKD paths: (a) the HyPr-Q network of two QLANs (square and circle) with (v₁, ∇₆) as source-destination nodes (circle QLAN), (b) the invalid path that contains an outside OTP operation at v₃ (square QLAN), and (c) the valid path with untrusted relay at the outside node v₂. In particular, in determining the protocol-link and constructing e2e QKD, one would like to explicitly account for the service-level objectives (SLOs) of demands, with the specific goal of meeting the e2e key-rate specified by the network demands.

Let P={s=v₁, v₂, . . . , v_{M}=d}, where v₁/=vⱼ, i/=j, and (vᵢ, vⱼ) E L, be a simple path from s to d in G. [If a key-rate flow γ_{P} can be allocated to a demand [symbol] s, d [symbol] by path P such that γ_{P}≥γ_{(s,d)}, we say that P is a feasible e2e QKD path to meet the SLOs of this demand.] Then, given a HyPr-Q network G with a set of demands D and limited network resources, where both trusted and untrusted nodes coexist, the main challenge becomes how to determine and construct optimal e2e QKD to maximize the number of demands that their SLOs are satisfied? Hereafter, this problem will be referred to as “SLOs-constrained Optimal end-to-end Hybrid-QKD (SOHQ)” problem as mathematically formulated as follows:

$$Objective : max {\sum }_{( \text{?} , d ) ∈ 𝒟} {1}_{\{ ∋ {𝒫}_{〈 \text{?} , d 〉 \text{?}} \geq \text{?} \}} \qquad ( 1 )$$

$$s . t . ( protocol - link capacity ) :$$

$${\sum }_{{𝒫}_{( u , v )}} γ𝒫 \leq {γ}_{( u , v )} * {L}_{( u , v )}^{b} , ∀ ( u , v ) ∈ ℒ \qquad ( 2 )$$

$${\sum }_{{𝒫}_{( u , w , υ )}} γ𝒫 \leq {γ}_{( u , w , υ )} * {L}_{( u , w , υ )}^{m} , ∀ ( u , w , υ ) ∈ ℒ \qquad ( 3 )$$

$$s . t . ( network resources ) :$$

$${\sum }_{( υ , u ) ∈ ℒ} {L}_{( υ , u )}^{b} + {\sum }_{( υ , w , u ) ∈ ℒ} {L}_{( υ , w , u )}^{m} \leq {ℛ}_{υ}^{Q} , ∀ υ ∈ 𝒱 \qquad ( 4 )$$

$${\sum }_{( u , υ ) ∈ ℒ} {L}_{( u , υ )}^{b} \leq {ℛ}_{υ}^{S} , ∀ υ ∈ 𝒱 \qquad ( 5 )$$

$${\sum }_{( u , υ , w ) ∈ ℒ} {L}_{( u , υ , w )}^{m} \leq {ℛ}_{υ}^{B} , ∀ υ ∈ 𝒱 \qquad ( 6 )$$

$$\text{?} \text{indicates text missing or illegible when filed}$$

The objective function in eq. 1 is to maximize the number of demands that their SLOs are satisfied (γ_{P}≥γ_{(s,d)}), in which the indicator function 1_{{·}} returns 1 if the subscript condition is true, and 0 otherwise. The capacity constraints in eq. 2-3 are to ensure that the allocated key-rate does not exceed the capacity established by the constructed protocol-link, in which, L^{b} denotes the number of constructed BB84

$${protocol - link}_{( u , w , υ )} ,$$

L^{m} denotes the number of ^{(u,v)} constructed MDI-QKD protocol-link, and P_{(u,v)}, P_{(u,w,v)} denote the paths that contains protocol-link (u, v) and (u, w, v), respectively. Additionally, the number of constructed protocol-link is bound by the network resources as shown in eq. 4-6. Specifically, the number of QTx at v limits the number of protocol-link that can be created where the qubits are transmitted from v (eq. 4). On the other hand, the number of protocol-link that are measured by [v, S] and [v, B] must not exceed the number of SRx and BRx given, respectively (eq. 5 and 6).

FIG. 8 illustrates examples of e2e QKD constructed by joint BB84 and MDI protocols. Given a HyPr-Q network with limited resources as shown in FIG. 8 one may remark that the e2e QKD construction is significantly influenced by the network conditions, including: 1) the presence of trusted and untrusted nodes in the network topology and 2) the availability of quantum devices. For instance, the e2e QKD path depicted in FIG. 8 is valid while another path in FIG. 8 is invalid due to: 1) v₁ and v₃ are untrusted towards each other since they belong to different QLANs; therefore, BB84 link-protocol cannot be deployed at (v₁, v₃). Additionally, 2) due to limited network resources, v₃ does not have a BRx device, not to mention v₄ lacks a QTx device; as a result, the MDI link-protocol cannot be deployed at (v₁, v₃, v₄).

### Theorem 1. The SOHO Problem is NP-Hard.

Proof. Assuming that one has the a polynomial solution for SOHQ, this means that one can construct the accurate set of protocol-link that would lead to the optimal solution within polynomial time. From this set of constructed protocol-link, a network key-rate capacity topology G=(V, C) can be derived in which the key-rate capacity between to nodes u, v∈V is aggregated as follows:

$${C}_{u , υ} = {γ}_{( u , υ )} * ( {L}_{( u , υ )}^{b} + {L}_{( υ , u )}^{b} ) + {\sum }_{w ; ( u , w , υ ) ∈ {ℒ}^{m}} {γ}_{( u , w , υ )} * {L}_{( u , w , υ )}^{m} \qquad ( 7 )$$

With a capacity topology G established, SOHQ becomes equivalent to the problem of All-or-nothing Multi-commodity Flow (AN-DMCF), which is NP-hard. Hence, if the SOHQ on G can be solved optimally in polynomial time, it would also be the case with the AN-DMCF problem, which is contradicting. This completes the proof for the theorem.

### Hierarchical-Structure-Based E2E QKD

HyPr-Q is designed with a complex topology and concurrently meeting the key-rate requirements of quantum applications at end-nodes is challenging. This requires QKD routing to be able to fully take advantage of the protocol-link to enhance the path diversity for meeting the SLOs in the face of limited resources and coexistence of trusted and untrusted nodes. In order to address these challenges, the present disclosures advocate for an innovative e2e QKD routing approach that is based on the hierarchical structure, dubbed hierarchical-structure-based e2e QKD (HSQKD). Our idea is to first enhance node connectivity by appropriately deploying the protocol-link (e.g., BB84 or MDI) in a hierarchical tree structure (e.g., spanning tree) in § IV-A: STAGE I. This approach effectively organizes network nodes in a hierarchical manner, allowing us to navigate the routing efficiently and enabling e2e QKD for all nodes in the network in § IV-B: STAGE II. The present disclosures organize the proposed HSQKD as illustrated in Alg. 1 as follows:

STAGE I: Protocol-Link Pre-Construction

STEP I. The first step in the protocol-link pre-construction stage aims to construct the spanning tree (rooted at any end-node) based on the HyPr-Q to connect all end-nodes. The present disclosures employ the Kruskal procedure to construct a spanning tree topology denoted as G^{T}=(V^{T}, E^{T}, C^{T}). Here,

$${C}_{u , v}^{T}$$

represents the key-rate capacity of the edge (u, v)∈E^{T}. To optimize the routing efficiency in the final graph (stage II), the present disclosures sort the set L in descending order based on their key-rates (lines 2-4 in Alg. 1). During this stage, each candidate protocol-link

$${l}_{u , v}^{C}$$

was examined connecting node u and v. The present disclosures carefully assess whether the inclusion of

$${l}_{u , v}^{C}$$

would expand the tree to cover a new region. If this condition is met, proceed to select the protocol-link

$${l}_{u , v}^{C} .$$

### Subsequently

one may add the corresponding edge (u, v) to the set E^{T} and assign the key-rate capacity

$${C}_{u , v}^{T}$$

the key-rate γ_{(u,v)} of this chosen protocol-link (lines 5-10). At the end of this stage, one may obtain the set L^{T}, which comprises all the selected protocol-link. Each of these links plays a crucial role in the e2e QKD construction.

STEP II. Having obtained the spanning tree from step I, the objective of the second step is to boost the key-rate capacity of edges, which represent the QKD links, by utilizing the remaining resources. To achieve this, the present disclosure provides an equitable distribution of resources, as available, to each edge on the tree. This is accomplished through a series of boost rounds. In particular, in each boost round, the key-rate capacity of an edge is enhanced by adding, at most, one protocol-link. The present disclosures thoroughly consider all edges in the tree topology before progressing to the subsequent boost rounds. This systematic approach leverages the most of the available resources while progressively improving the key-rate capacity of the QKD links in the network (lines 11-18).

### STAGE II: Hierarchical Routing Approximation

The hierarchical LCA order. Within the tree topology G^{T} established during the previous stage, the present disclosures present a hierarchical routing algorithm (HRA) specifically designed to facilitate e2e QKD for the network demands. The algorithm's details are outlined in Alg. 2. The HRA algorithm demonstrates a

$$\frac{1}{2} - approximation rate ,$$

particularly when the key-rate requirements are uniformly consistent across all demands.

Algorithm 1: Protocol-link: Pre-Construction (PPC)

```
      Input: [symbol]  ( [symbol] , ε, [symbol] ), [symbol]
      Output: [symbol] ^{T} ( [symbol] ^{T}, ε^{T}, [symbol]  ^{T})
  1 STEP I: Maximize connectivity
  2 Sort [symbol]   by key-rate in descending order;
  3 [symbol]   ← Ø; //Set of selected protocol-link
  4 Tᵥ ← v, ∀v ∈ [symbol] ;
  $5 foreach {l}_{u , υ}^{C} ∈ ℒ do$
  $6 \vert if sufficient resources for {l}_{u , υ}^{C} and {T}_{u} \neq {T}_{υ} then$
  $7 \vert \vert Remove {l}_{u , υ}^{C} ’ s resource from the network ;$
  8 | | UNION(Tᵤ, Tᵥ);
  $9 \vert \vert {ℒ}^{T} ← {ℒ}^{T} ⋃ {l}_{u , υ}^{C} ;$
10 └ └  ${ε}^{T} ← {ε}^{T} ⋃ ( u , v ) ; {C}_{u , υ}^{T} ← {γ}_{( u , υ )} ;$
11 STEP 11: Capacity enhancement
12 while [symbol]  ^{T} ≠ ∅ do
$13 \vert foreach {l}_{u , υ}^{T} ∈ {ℒ}^{T} do$
14 | | if sufficient resources for l^{T} then
15 | | | Remove l^{T}'s resource from the network;
16 | | └  ${C}_{u , υ}^{T} ← {C}_{u , υ}^{T} + {γ}_{( u , υ )} ;$
17 | | else
18 └ └ └ [symbol]  ^{T} ← [symbol] ^{T}\l^{T};
19 return [symbol] ^{T} ( [symbol] ^{T}, ε^{T}, [symbol] ^{T})
```

Algorithm 2: Hierarchical Routing Algorithm (HRA)

| | Input: G^{T} (V^{T}, E^{T}, C^{T}), D, r | | |
|---|---|---|---|
| | Output: Best selection of demands | | |
| 1 | Let lca(i) be the lowest common ancestor of s [symbol] and d [symbol] | | |
| | with i ∈ D: | | |
| 2 | Let depth(v) be the distance between r and v; | | |
| 3 | Sort D such that: | | |
| | depth(lca(i)) ≥ depth(lca(i + 1)) ∀i ∈ D; | | |
| 4 | k ← ∅; //Selected demands | | |
| 5 | foreach i ∈ D do | | |
| 6 | \| | if sufficient resource for i then | |
| 7 | \| | \| | k ← k ∪ { [symbol] } [symbol] |
| 8 | └ | └ | Remove i [symbol] s resources from C^{T} [symbol] |

| | |
|---|---|
| 9 | return k |

[symbol]

indicates data missing or illegible when filed

Given the spanning tree topology, where only a single path exists between any two nodes, it is important to remark that obtaining an optimal routing solution is equivalent to selecting a sequence with minimal resource conflicts. The algorithm accomplishes this by establishing a specific order of demand selection. Let us consider the tree G^{T} rooted at r (any node in the network). For each demand i, the algorithm identifies the lowest common ancestor (LCA) of its source-destination pair, denoted as l_{ca}(i) (line 1). Subsequently, it calculates the depth of l_{ca}(i) representing the distance of this vertex from the root r (line 2). Then, the demands is sorted in a non-increasing order based on their depth (line 3). Following this order, the algorithm prioritize fulfilling the demands with LCAs that are further away from the root first (lines 4-8). This is because the source-destination pairs whose LCAs are further away from the root are less likely to have resource conflict with each other, moreover, they tend to have shorter e2e QKD paths, which means less resource consumption. Let's consider an example, where v₁ is chosen as the root node, v₂ is positioned farther away from the root v₁ itself. As a consequence, the demand pair (s₁, d₁) will be prioritized and routed before any other demands in the network. This is because v₂ is the LCA of [symbol] s₁, d₁ [symbol] , while v₁ is the LCA of [symbol] s₂, d₂ [symbol] , [symbol] s₃, d₃ [symbol] , and [symbol] s₄, d₄ [symbol] .

### Analysis: Time Complexity and Approximation Rate

Time complexity of PPC: The size of possible protocol-link L is |L^{b}|+|L^{m}]=|E|+|V|³. Hence the complexity of STEP I is O((|E|+|V|³)log|E|+|V|³). Let Rₘₐₓ be the maximum number of devices could be given to a node. The complexity of STEP II is O(|V|*Rₘₐₓ).

Time complexity of HRA: The complexity of discovering the LCA of each demands, sorting the demands, and routing the demands is O(|D|V|+|D|log(|D|)+|D|V|)=O(|D|*(|V|+log(|D|)).

Approximation of HRA: The following theorem is stated about the approximation of STAGE II.

Theorem 2. When the key-rate requirements of the demands are uniform, i.e. γ₁=γ₂= . . . =γ_{|D|}, the hierarchical routing algorithm achieves a lower-bound

$$\frac{1}{2} - approximation .$$

Proof. Let S_{OPT} be the optimal set of demands to be fulfilled and S_{HR} be the one that is produced by HRA. Consider a demand i∈S_{HR}, the path from sᵢ to dᵢ can be broken down into two continuous segments: P(lca(i), sᵢ) and P(lca(i), dᵢ). Now let us consider a demand j ∈S_{OPT} at the upper hierarchy, i.e. depth(lca(j))<depth(lca(i)). Similarly with the path from sⱼ to dᵢ, one also has [symbol] =P(lca(j), sⱼ) UP(lca(j), dⱼ). Let us assume that P(sj, dj) overlaps with P(sᵢ, dᵢ> at P_{OLP}. Because G^{T} is a tree, P_{OLP} must be a continuous segment. Since depth (lca(i))>depth(lca(j)), we have: 1) P_{OLP} only occurs on either P(lca(i),sᵢ) or P(lca(i),dᵢ), not both at the same time and 2) One end node of P_{OLP} must be lca(i). Without loss of generality let us assume that P_{OLP}∈P(lca(i), sᵢ). The present disclosures state the following lemma.

Lemma 1. If the demand i is fulfilled and it causes saturation on any set of edges in P(lca(i), sᵢ), i.e. no more demands can be routed on this edge. Then the maximum number of demands, which 1) are at the upper hierarchy and 2) belong to S_{OP T}, that would be deprived of being fulfilled, is one.

Proof. To prove this lemma, let us hypothesize that there are two such demands j₁, j₂∈S_{OP T}, in which depth(lca(j₁))>depth(lca(i)) and depth(lca(j₂))>depth(lca(i)). Let POLP₁ and P_{OLP2} be the overlapping segments of P<sj₁,dj₁> and P<sj,dj> with P(lca(i), sᵢ). Let us say that the set of saturated edges e contains two sets: e₁⊂P_{OLP1} and e₂⊂P_{OLP2} that deprive j₁, j₂ from being fulfilled. And since γᵢ=γᵢ₁=γⱼ₂, it must be the case that e₁ and e₂ are mutually exclusive, or e₁⊆P_{OLP1}\P_{OLP2} and e2⊆P_{OLP2}\P_{OLP1}. This means that |P_{OLP1}\P_{OLP2}|>0 and |P_{OLP2}\P_{OLP1}|>0. This is not possible since P_{OLP1}, P_{OLP2} and P(lca(i), sᵢ) are continuous segments while both P_{OLP1}, P_{OLP2} share one end node lca(i) and are contained by P(lca(i), sᵢ). This discards the hypothesis and completes the proof for the lemma.

Generalizing Lemma 1 to P(_{lca}(i), dᵢ), one may conclude that the fulfillment of a sub-optimal demand i∈SHR can only deprive resources of maximum two other demands from S_{OP T} at the upper hierarchy. This means that

$$\vert {S}_{HR} \vert \geq \frac{\vert {S}^{OPT} \vert}{2} ,$$

which completes the proof for the theorem.

### Approach II: On-the-Fly E2E Qkd

In § IV, attaining a high number of demands with satisfied SLOs can be facilitated by constructing protocol-link in conjunction with the demand routing process. This second approach aims to optimize the use of protocol-link efficiently, minimizing redundancy in certain areas while avoiding shortages in others. Unlike the first approach separating the protocol-link construction and routing processes, this method ensures that each protocol-link is constructed only when it is specifically required for a particular demand. By parallelizing the protocol-link construction and routing, one can utilize the given limited network resources more effectively, thus enhancing the overall performance and resource utilization of the network. This approach is geared towards maximizing the network's e2e QKD capability to fulfill demands while minimizing the unnecessary resource allocation.

### Algorithm Description

OVERVIEW. The disclosure provides an overview of the proposed on-the-fly E2E QKD. The procedure, which entails the simultaneous integration of protocol-link construction and routing, is broken down into the following steps.

In each routing iteration, PATH_FINDER determine tentative e2e QKD paths connecting demands taking into account the status of current (remaining) network resources.

The demand with the most resource-efficient (cheapest) path, evaluated by the ORACLE, is given priority, leading to the construction of the corresponding e2e QKD, and updating of the resource status accordingly.

Algorithm 3: Device-to-device PATH_FINDER

| | Input: i(sᵢ, dᵢ, κᵢ) ∈ D [symbol] G(V, E, R) | | | |
|---|---|---|---|---|
| | Output: Resources for a path to dᵢ | | | |
| 1 | Initialization: P [symbol] ← ∅; [symbol] queue([sᵢ, Q], 0): | | | |
| 2 | while Q/= ∅ do | | | |
| 3 | \| | [v, x] ← [symbol] dequeue( ); V_{[v,x]} ← true [symbol] | | |
| 4 | \| | if v = dᵢ and x ∈ {Q, S} then | | |
| 5 | \| | └ | return P_{[v,x]} | |
| 6 | \| | Let Eᵥ be the adjacent nodes of v; | | |
| 7 | \| | Let Zₓ denotes the set of devices than is possible | | |
| | \| | to be visited from x: | | |
| | \| | | | ′{Q, S, B}, if x ∈ {Q, S} |
| | \| | Zₓ = | | |
| | \| | | | {Q}, if x = B |
| 8 | \| | foreach (u, z) ∈ {Eᵥ × Zₓ} do | | |
| 9 | \| | \| | if (V^{u}/= V^{si} and z ∈ {Q, S}) or | |
| | \| | \| | (V [symbol] is true) then continue [symbol] | |
| 10 | \| | \| | Let λ be the protocol-link from [v, x] → [u, z] [symbol] | |
| 11 | \| | \| | if not sufficient resource for λ then continue [symbol] | |
| 12 | \| | \| | if ORACLE(P_{[u,z]}) > ORACLE(P [symbol] ∪ λ) then | |
| 13 | \| | \| | \| | P_{[u,z]} ← P_{[v,x]} ∪ λ [symbol] |
| 14 | └ | └ | └ | [symbol] upqueue([u, z], ORACLE(P_{[u,z]})); |

| | |
|---|---|
| 15 | return ∅ |

[symbol]

indicates data missing or illegible when filed

The above process is repeated iteratively until all demands are successfully routed, or if there are insufficient remaining resources to fulfill any of the remaining un-routed demands.

PATH FINDER. PATH_FINDER is designed as a Dijkstra-based algorithm that discovers the best e2e QKD paths for demands. The details of PATH_FINDER are outlined in Alg. 3. It employs ORACLE as a comparison tool to determine the best path. Let's consider an example, where a direct QKD path connecting v₁ to v₃ might not be feasible due to the absence of a SRx in v₃ to facilitate the BB84 protocol. However, within the same network, one can explore an alternative path, that involves routing from source s=v₁ through v₂ and then back to v₁ before reaching destination d=v₃. Obviously, this path can be feasibly constructed using existing quantum devices available in v₁, v₂, and v₃. This realization encourages us to advocate for an innovative device-to-device path discovery as follows.

Device-to-device path discovery. Starting at [sᵢ, Q], for each device [v, x] visited, if it is a destination device, then the e2e QKD path is returned (lines 3-5). Otherwise, the algorithm goes through the list of potential devices at the adjacent nodes that can be visited from [u, x]. If the resources are sufficient to reach an adjacent device as such, then it will be considered to be in queued for subsequent visiting iterations (lines 6-14).

ORACLE. Here, one may use the ORACLE (lines 12-14) as a function to determine the best source-efficient (cheapest) e2e QKD path, it is important to note that as a path is composed of a series of protocol-link, the resource consumption of a path is the total resource consumption of the protocol-link:
ORACLEₚ=Σ_{(u, v)∈P}ORACLE_{(u, v)}. The resource consumption score at a BB84 protocol-link (u, v) is:

$${ORACLE}_{( u , υ )} = 2 * \frac{γ \text{?}}{γ \text{?}}$$

$$\text{?} \text{indicates text missing or illegible when filed}$$

while the resource consumption score of an MDI link is:

$${ORACLE}_{( u , w , υ )} = 3 * \frac{γ \text{?}}{γ \text{?}} .$$

$$\text{?} \text{indicates text missing or illegible when filed}$$

The key idea behind this formula is to encourage the construction protocol-link that use less QKD devices and with higher key-rate capacity.

### Analysis

Complexity of device-to-device PATH_FINDER: The number of visiting entities, i.e. devices, is 3*|V|, the number of edges between them is (Σ_{x∈{O,S,B}}|Zₓ|)*|E|=7*|E|. The complexity of device-to-device Dijkstra with resource veri-fication and ORACLE evaluation is O((7*|E|)*log(3*|V|)*(3*|V|))=O(|E∥V|log(|V|)).

Complexity of OEQ: After each routing iteration, the remain-ing resources is updated, hence the paths of all demands must be re-discovered with the PATH_FINDER. Thus, the complexity of OEQ is O(|D|²*|E∥V|log(|V|)).

### Network Protocols Realization

The present disclosures develop relevant quantum network simulation modules leveraging the NetSquid quantum network simulator library to realize and test the feasibility of a joint BB84-MDI QKD deployment. Initially, a meticulous stochastic analysis of the BRx optical setup may be conducted. Subsequently, leveraging IBM Qiskit, the present disclosure presents the-first-of-its-kind BRx quantum circuit tailored for the realization of the MDI-QKD protocol. This BRx design is then utilized to implement MDI-QKD within the NetSquid. The implementation of joint BB84-MDI QKD in this section will facilitate a comprehensive validation of HyPr-Q and the proposed algorithms in § VII.

### NetSquid Setup

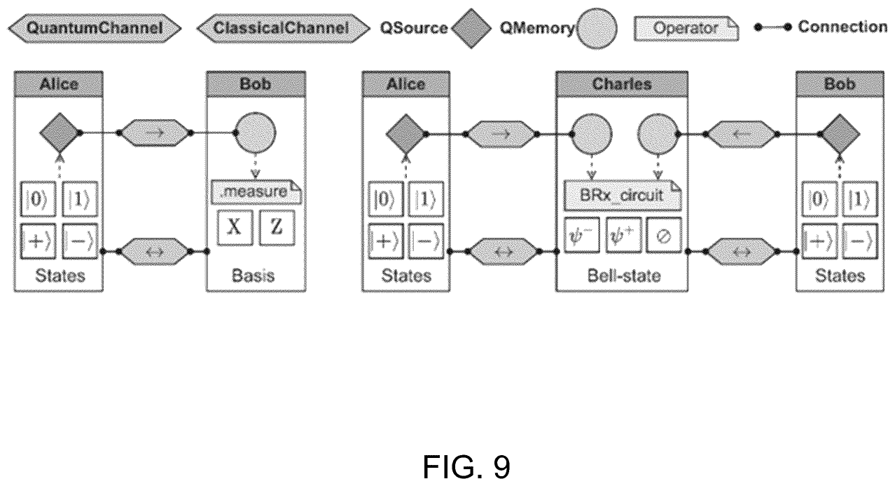

FIG. 9 shows a design for quantum network simulator modules: a communication setup of (a) BB84 and (b) MDI-QKD. FIG. 9 gives an overview of the quantum simulation modules with NetSquid library with the communication model of BB84 in FIG. 9 and MDI-QKD in FIG. 9. The details are described as follows.

Communication media: QuantumChannel is implemented with the FiberLossModel of 0.18 dB to transmit the qubits, while ClassicalChannel is embedded with the FiberDelayModel characterized by the propagation speed of 2·10⁵ km/s.

Transmission: The present disclosures implement the QTx using QSource component, in which the photon emission frequency 80 MHz is emulated by the timing model.

Reception: The Qmemory class is implemented to receive the qubits, with the parameters DepolarNoiseModel and De-phaseNoiseModel emulate the polarization success probability of 8·10⁻³ and fiber dephase probability of 0.02.

Measurement: The Qmemory component is built-in with .qubits APIs which is embedded with the quantum operator execution time of 1 ns. For SRx, the .measure API is used with basis switching between X and Z. With BRx, a customized quantum circuit is provided, called BRx . . . circuit. This circuit design will be discussed in the next section.

### Qiskit: BRx Circuit Design

While the implementation of SRx can be relatively straight-forward, the challenge in implementing the BRx lies in projecting a pair of qubits into a Bell-state with identical stochasticity of the optical setup, which is not inherently supported by the NetSquid library. To address this issue, one may delve into the specifics of designing and testing the BRx quantum circuit.

Optical analysis. The present disclosures perform a stochastic input/output analysis of BRx based on an optical setup. The input photon can be polarized in four directions: {|H [symbol] , |V [symbol] , |D [symbol] , |A [symbol] }. The corresponding Bell-state projection outcomes are denoted as {ψ⁻, ψ⁺, Ø}, where: ψ represents a simultaneous detection of {D1H, D2V} or {D2H, D1V}; ψ⁺ represents a simultaneous detection of {D1H, D1V} or {D2H, D1V}; and Ø signifies unsuccessful projections.

BRx circuit design. In this circuit, q₀ and q₁ represent the input photon pair, while q₆₋₉ indicate the relay output as follows: q₆=|1 [symbol] if the result corresponds to ψ⁻ in rectilinear, i.e. {ψ⁻, +}; similarly, q₇=|1 [symbol] for {ψ⁺, +}; q₈=|1 [symbol] for {ψ⁻, x}; and q₉=|1 [symbol] for {ψ⁺, x}. To ensure the accuracy of this circuit, one may conduct a Qiskit simulation with 2¹⁴=16384 trials per input scenario.

### Protocol Realization and Key-Rate Benchmarking

The results show that the loss rate applied to MDI-QKD is lower than that of BB84, as photons only need to travel half the distance in MDI-QKD. At relatively shorter distances ranging from 10 to 25 km, BB84 yields a higher key rate compared to MDI-QKD. This difference arises from the variation in measurement efficiency between the two protocols. Specifically, in BB84, there is a 50% chance of measurement success, while in MDI-QKD, this probability is 21.875%. However, as the distances extend beyond 40 km, the advantage in key rate shifts towards MIDI-QKD due to the significant increase in photon loss experienced by the BB84 protocol.

With the obtained key-rate results, one may continue constructing two 3×3 grid networks of HyPr-Q and P2P-QKD models to compare the efficiency of average key-rate per device between them. In small-scaled networks, HyPr-Q is less efficient than P2P-QKD due to extra devices. However, in long-distanced networks, HyPr-Q becomes up to three times more efficient than P2P-QKD thanks to the extra devices.

### Algorithm Benchmarking

Building upon the protocols' implementation and results presented in § VI, the present disclosures further benchmark the effectiveness of HyPr-Q and the proposed algorithms using NetSquid. Each simulation involves randomly generated network topologies with a node count ranging from 20 to 50, and point-to-point fiber connections spanning 30 to 70 km. Additionally, each node can host up to 6 QKD devices. The key-rate requirement for each demand is randomized between 1-3 Mbps.

Benchmarked algorithms. The present disclosures benchmark the algorithms as follows. For “Approach I: Hierarchical-structured-based E2E QKD”, the present disclosures implement the Hierarchical Routing Algorithm in two setups: Hierarchical Routing Random (HRR) and Hierarchical Routing Search (HRS). In HRR, the algorithm employs a random root for constructing the tree, while in HRS, all nodes are tested as the root to find the root that yields the best selection. The objective is to assess the significance of root selection in the hierarchical ordering process of the algorithm. Additionally, to compare the efficiency of HRR and HRS with the optimal solution, one may implement the Brute Force Algorithm (BFA), which yields the optimal routing solution on a tree, albeit with exponential time complexity. With “Approach II: On-the-fly E2E QKD (OEQ)”, our focus is on testing the efficiency of two path discovery methods: 1) the proposed device-to-device method, namely OEQD, and 2) the node-to-node path discovery method, namely OEQN, both integrated into the proposed PATH_FINDER process. In the following, the present disclosures evaluate the proposed algorithms from four perspectives. Firstly, the present disclosures illustrate the performance of the algorithms in terms of the number of fulfilled demands and their convergence time across different network topologies. Secondly, the present disclosures demonstrate that the proposed algorithms optimize resource utilization and path control performance effectively, even in diverse network scales, including scenarios with a high number of nodes.

### Number of Fulfilled Demands and Protocol Convergence Time

The OEQ consistently outperforms BFA, HRR, and HRS by a factor of two. However, this performance gap diminishes as the number of nodes or unit distance increases. The effectiveness of HRS in most cases comes close to that of BFA, and the significance of searching for the best root becomes apparent when comparing HRS with HRR. OEQD proves to be less time-efficient than OEQN, primarily because the device-to-device path finder entails three times more visiting entities than its node-to-node counterpart. As for Approach I, the execution time of BFA increases drastically with the number of demands due to the growing number of routing possibilities it needs to manage. On the other hand, HRS and HRR demonstrate relatively little change in execution time.

### Resource Consumption and Path Control.

The OEQ approach demonstrates superior device efficiency. Specifically, OEQD initially achieves significantly higher de-vice efficiency, but this advantage diminishes and levels with OEQN as higher distances lead to resource-deprivation conditions. The results reveal an increasing trend of BRx consumption by OEQD as the number of QLANs increases. However, for the other algorithms, there is little change in BRx consumption.

A first algorithm, OEQD\C, fulfills the demands in chronological order without prioritizing those with the “cheapest” path. PATH_FINDER no longer needs to be run for every demand at each routing iteration, resulting in reduced time complexity during execution. A second algorithm, OEQD\S, involves sorting the set of demands by ORACLE only once at the beginning, which determines the order of demand fulfillment. Results show that OEQD\S slightly underperforms OEQD but still outperforms OEQD\C by a considerable margin. This indicates that OEQD\S can be a less time-complexity alternative to OEQD without sacrificing much in terms of performance.

In this disclosure, a novel joint BB84-MDI QKD model is described and called the HyPr-Q, which combines BB84 and MDI QKD. The goal is to maximize the number of demands at which their SLOs are met while their e2e QKD paths are constructed using the joint BB84-MDI QKD, referred to as the SLO-constrained Optimal end-to-end Hybrid-QKD (SOHQ) problem. As an example, two approaches are proposed to address the SOHQ problem. Firstly, one may optimize the protocol-link pre-construction phase using a hierarchical structure, and secondly, one may focus on the key distribution routing phase using “on-the-fly” routing approximation computation. The research includes a comprehensive evaluation, utilizing NetSquid and IBM Qiskit, to validate the potential of the joint BB84-MDI QKD. The present disclosures benchmark the proposed algorithms from four perspectives: 1) the number of fulfilled demands; 2) the convergence time of the algorithms; 3) network resource utilization efficacy; and 4) path control performance. The evaluation results demonstrate the high potential and promising outcomes of the joint BB84-MDI QKD.

What is claimed is:

1. A system for implementing a quantum key distribution network, the system comprising:
one or more quantum transmitters configured to transmit quantum encoded photons;
a single state receiver, configured to receive the photons and determine encoded bits under a first protocol;
a bell state receiver configured to receive quantum encoded photons under a second protocol; and
a manager configured to determine a basis of encoding of the quantum encoded photons and to control communication between the one or more quantum transmitters and the single state receiver based on the first protocol or the bell state receiver based on the second protocol.

2. The system of claim 1, further comprising a polarization modulator associated with the one or more quantum transmitters to set a polarization direction of the quantum encoded photons.

3. The system of claim 1, further comprising a polarization modulator associated with the single state receiver to set a measurement basis for received quantum encoded photons.

4. The system of claim 1, wherein the bell state receiver comprises:
a polarizing beam splitter; and
a beam splitter.

5. The system of claim 1, wherein under the second protocol the bell state receive is configured to receive a pair of incoming photons from at least two of the quantum transmitters and the bell state receiver is configured to project the pair of incoming photons into a bell state, whereby a successful measurement event results in either ψ+ or ψ−.

6. The system of claim 1, wherein the photons are encoded in one of four (4) polarization directions horizontal, vertical, horizontal, vertical, diagonal and anti-diagonal.

7. The system of claim 1, wherein the first protocol comprises BB84.

8. The system of claim 1, wherein the second protocol comprises MDI-QKD.

9. A method for periodically supplying secret keys for securing communication between multiple networks, the method comprising:
determining, using a controller one or more quantum key distribution resources;
determining a control sequence based on the one or more quantum key distribution resources;
transmitting the control sequence to a quantum protocol manager;
executing, via the quantum protocol manager, the control sequence based on at least one of a plurality of protocols to generate a secret key; and
executing a software application via an applications layer connected by a plurality of data channels, where the software application run and communicate securely using the secret key, thereby securing the software application.

10. The method of claim 9, wherein the controller comprises a software defined networking (SDN) controller.

11. A system for implementing a quantum key distribution network, the system comprising:
one or more quantum transmitters configured to transmit quantum encoded photons;
a first polarization modulator associated with the one or more quantum transmitters to set a polarization direction of the quantum encoded photons;
a single state receiver, configured to receive the photons and determine encoded bits under a first protocol;
a second polarization modulator associated with the single state receiver to set a measurement basis for received quantum encoded photons;
a bell state receiver configured to receive quantum encoded photons under a second protocol; and
a manager configured to determine a basis of encoding of the quantum encoded photons and to control communication between the one or more quantum transmitters and the single state receiver based on the first protocol or the bell state receiver based on the second protocol.

12. The system of claim 11, wherein the bell state receiver comprises:
a polarizing beam splitter; and
a beam splitter.

13. The system of claim 11, wherein under the second protocol the bell state receive is configured to receive a pair of incoming photons from at least two of the quantum transmitters and the bell state receiver is configured to project the pair of incoming photons into a bell state, whereby a successful measurement event results in either ψ+ or ψ−.

14. The system of claim 11, wherein the photons are encoded in one of four (4) polarization directions horizontal, vertical, horizontal, vertical, diagonal and anti-diagonal.

15. The system of claim 11, wherein the first protocol comprises BB84.

16. The system of claim 11, wherein the second protocol comprises MDI-QKD.
